(19) United States
(12) Patent Application Publication
(10) Pub. No.: US 2018/0123349 A1
(43) Pub. Date: May 3, 2018

(54) MODULAR POWER SUPPLY AND STORAGE PRODUCTS

(71) Applicant: IAP Worldwide Services, Inc., Cape Canaveral, FL (US)

(72) Inventors: Peter Gleave, Dorset (GB); Philip Robinson, Dorset (GB)

(21) Appl. No.: 15/797,781

(22) Filed: Oct. 30, 2017

Related U.S. Application Data
(60) Provisional application No. 62/416,035, filed on Nov. 1, 2016.

(51) Int. Cl. H02J 3/46; H02K 7/18; H02J 7/00; H02J 3/32

(52) U.S. Cl. CPC H02J 3/46; H02K 7/1815; F02B 63/044; H02J 3/32; H02J 7/0068

(57) ABSTRACT

Disclosed herein is a modular power supply system and method for controlling the same. In one embodiment, a modular power supply is disclosed comprising a housing comprising an equipment enclosure conforming to the requirements of an ISO container; a plurality of power generation modules housed at respective ends of the housing, a respective power generation module including a variable speed diesel engine coupled to a generator, a pair of rectifiers coupled to the generator, a pair of inverters coupled to the rectifiers, an LCL filter coupled to each inverter, a breaker coupled to each LCL filter, the breakers connected to a central AC power bus; and a plurality of energy storage subsystems housed at respective ends of the housing, a respective energy storage subsystem comprising one or more batteries connected to a pre-charge circuit, a DC/DC boost converter connected to the pre-charge circuit, and a DC power bus connected to the input of the inverters.

### CROSS-REFERENCE TO RELATED APPLICATIONS

This application claims the benefit of priority of Provisional Application No. 62/416,035, titled “Modular Power Supply and Storage Products,” filed on Nov. 1, 2016, which is hereby incorporated by reference in its entirety.

### BACKGROUND

The present disclosure relates to electrical power supplies and, in particular, to modular power supplies and methods of controlling such supplies.

Currently, power supply systems are designed to provide power/energy to areas temporarily or permanently disconnected from fixed power sources (e.g., power plants, utility power supplies, etc.). Examples include areas affected by disasters, remote and underdeveloped regions, and temporary installations. Many current systems are simplistic and haphazardly organized. In general, diesel fueled generators and/or renewable power sources are the source of temporary electrical power supplies.

Current systems for providing power to these areas suffer from numerous deficiencies. First, currently available equipment is not configured or controlled in a manner which promotes the optimum efficiency. This places a strain on the operating costs of the plant, supply lines and related logistics support due to fuel demands to sustain operation and often requires multiple plants to ensure the continuity of electrical power supply.

The inefficiencies primarily arise because in the majority of cases the electrical load attached to the plant varies over time and season due to the utilization of the equipment attached. The diesel engine is typically operated at constant speed and the output controlled by varying the excitation of the alternator. The alternators which are currently used also produce electrical noise which can be deleterious to certain sensitive electronic equipment which may be connected to the plant and are less efficient than alternative types. The efficiency of diesel engine falls significantly as the load drops. When a diesel engine is operated at partial or low load the maintenance requirements on the engine increases. In order to assure the continuity of supply the common remedy is to have multiple generators connected and engines running ‘on standby’ which exacerbates the inefficient use of fuel and increases the maintenance requirements. If renewables are available they are often a separate “stand-alone” system and not integrated with any diesel fueled generators.

To remedy these deficiencies, equipment and a method of packaging configuring and utilizing equipment is disclosed, together with a supervisory control system and method that manages the use of energy storage subsystems and power generation subsystems to optimally deliver power using both devices while minimizing the strain on the power generation subsystem.

### BRIEF SUMMARY

The following descriptions of examples of methods and systems are not intended to limit the scope of the description to the precise form or forms detailed herein. Instead, the following description is intended to be illustrative only and others may still follow and implement the teachings herein.

The instant disclosure provides a modular power supply that offers a significantly lower cost of operation than conventional diesel generator sets. The modular power supply is particularly effective where power requirements are subject to a substantial variance in demand over a period (such as over a 24-hour period or as the seasons or usage change) and/or sustained periods of low load operation. The modular power supply may also be readily shipped and easily deployable into remote locations where there is little power supply infrastructure or in locations where a particular high-quality (i.e., low electrical noise) power output is required.

In one embodiment, a modular power supply system is disclosed comprising: a housing comprising an equipment enclosure conforming to the requirements of an ISO container; a plurality of power generation modules housed at respective ends of the housing, a respective power generation module including a variable speed diesel engine coupled to a generator, a pair of rectifiers coupled to the generator, a pair of inverters coupled to the rectifiers, an LCL filter coupled to each inverter, a breaker coupled to each LCL filter, the breakers connected to a central AC power bus; and a plurality of energy storage subsystems housed at respective ends of the housing, a respective energy storage subsystem comprising one or more batteries connected to a pre-charge circuit, a DC/DC boost converter connected to the pre-charge circuit, and a DC power bus connected to the input of the inverters.

In one embodiment, a supervisory control system is disclosed comprising a communications bus; a power controller coupled to the communications bus and including programmable logic configured to monitor a power demand attached to a power supply system managed by the supervisory control system; a DC power controller coupled to the power controller via the communications bus and including programmable logic configured to manage the operation of an energy storage subsystem included in the supervisory control system, wherein the DC power controller includes programmable logic configured to operate the energy storage system in a voltage control mode; and a power generation controller coupled to the power controller via the communications bus and including programmable logic configured to manage power electronics and an power generation subsystem included in the supervisory control system, wherein the power generation controller is brought online by the power controller if the power controller detects that the power demand placed on the power supply system is more than transient.

In one embodiment, a method is disclosed comprising detecting the presence of a power demand on a modular power supply, the modular power supply including a power generation subsystem and energy storage subsystem; powering the power demand via the energy storage subsystem in response to detecting the presence of the power demand; enabling AC power generation in response to determining that the power demand is not a transient demand; monitoring a state of charge of the energy storage system; and targeting a net power flow upon determining that the state of charge of the energy storage system falls below a predetermined level.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIGS. 1 through 4 are schematic diagrams of a modular power supply housing according to some embodiments of the disclosure (respectively at elevation, front, and side views).

FIGS. 5 through 9 are schematic diagrams of a modular power supply according to some embodiments of the disclosure.

FIG. 10 is an isometric view of a single power supply unit of the modular power supply according to some embodiments of the disclosure.

FIG. 11 is a circuit diagram of a modular power supply according to some embodiments of the disclosure.

FIG. 12 is a system diagram of a supervisory control system according to some embodiments of the disclosure.

FIG. 13 is a flow diagram illustrating a method for optimizing generation efficiency of a modular power supply according to some embodiments of the disclosure.

FIG. 14 is a graph of the output voltage and power of an energy storage device according to some embodiments of the disclosure.

FIGS. 15A-15D are graphs of the output power of various components of a modular power supply when subjected to various power demands.

FIG. 16 illustrates the improved, reduced fuel consumption achieved the disclosed embodiments.

FIG. 17 is a graph illustrating an optimum operating line according to some embodiments of the disclosure.

### DETAILED DESCRIPTION

The present disclosure will now be described more fully hereinafter with reference to the accompanying drawings, which form a part hereof, and which show, by way of illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Described herein is a modular power supply and control system. The modular power supply includes one or more power generation subsystems including engines and power electronics which provide AC power to a single AC power bus. The power electronics additionally supply DC power to a DC power bus that charges an energy storage system. Additionally described herein is a supervisory control system that manages the components of the modular power supply and optimizes generation efficiency of the supply.

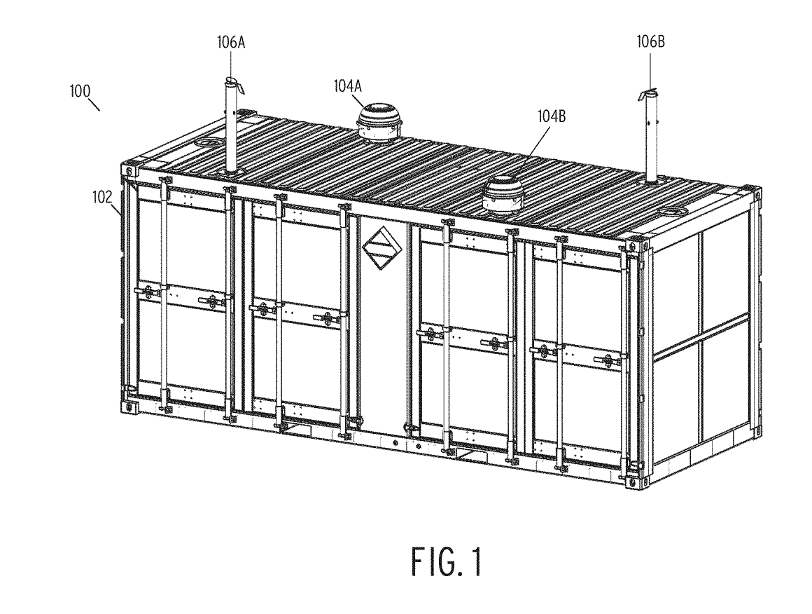

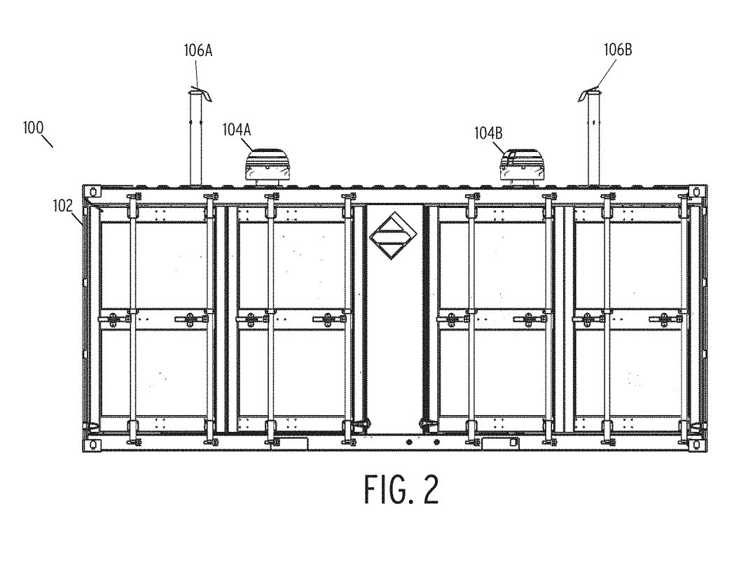

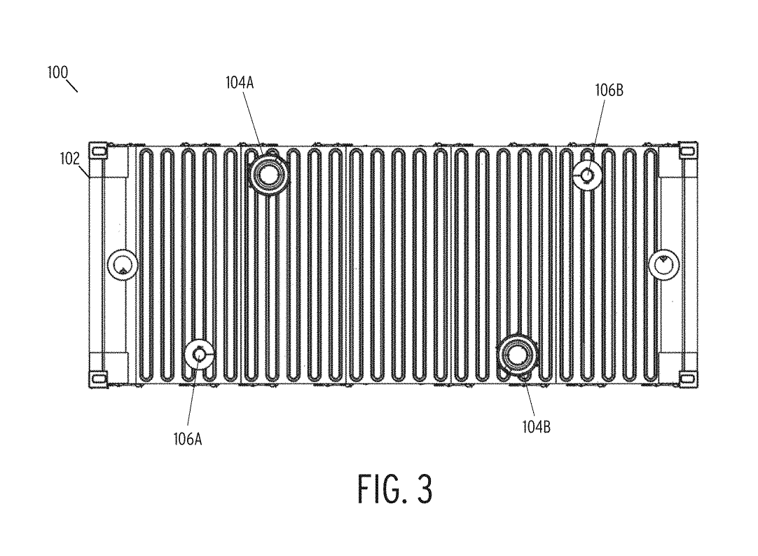

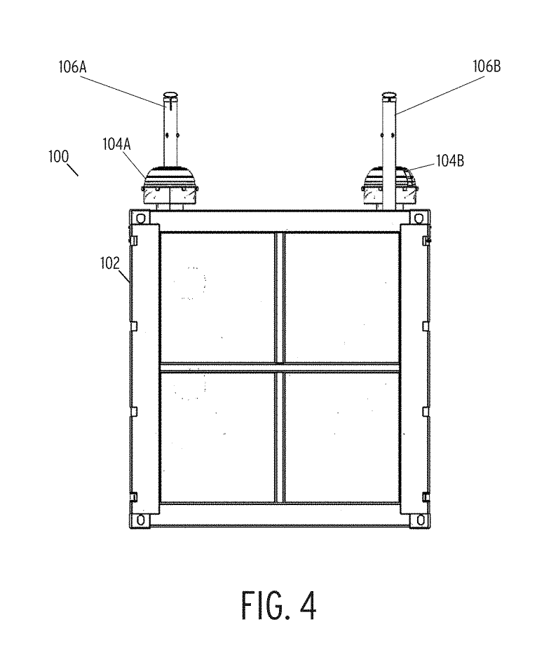

As illustrated in FIGS. 1-4, the modular power supply (100) may be deployable in a housing (102) comprising an equipment enclosure. In one embodiment, the equipment enclosure conforms to the requirements of a standard container. In one embodiment, the standard container comprises an ISO container. In one embodiment, an ISO container comprises a 20-foot ISO 6346 1CC container. As a result, the modular power supply (100) may be transported using existing commercial and military trucking and shipping means. Depending on the location, the modular power supply (100) (“plant”) may be configured to operate effectively in the environment and/or ruggedized.

In some embodiments, the modular power supply (100) may additionally include one or more sound baffles or mufflers in order eliminate or reduce noise caused by the operation of the power generation modules (108A, 108B). Alternatively, or in conjunction with the foregoing, the modular power supply (100) may additionally include a heat shield, heat sinks, or other thermal dissipating (or heat exchanging) components to eliminate or reduce the external heat signature of the modular power supply (100).

The housing (102) of the modular power supply (100) may include one or air intake ports (104A, 104B) and/or exhaust ports (106A, 106B). For example, as illustrated in FIGS. 1-4, the housing (102) may include two intake ports (104A, 104B) and two exhaust ports (106A, 106B), in an embodiment. As will be described below, the modular power supply (100) may include two power generation modules (108A, 108B), each of which may be coupled to a respective one of the two illustrated intake ports (104A, 104B) and exhaust ports (106A, 106B).

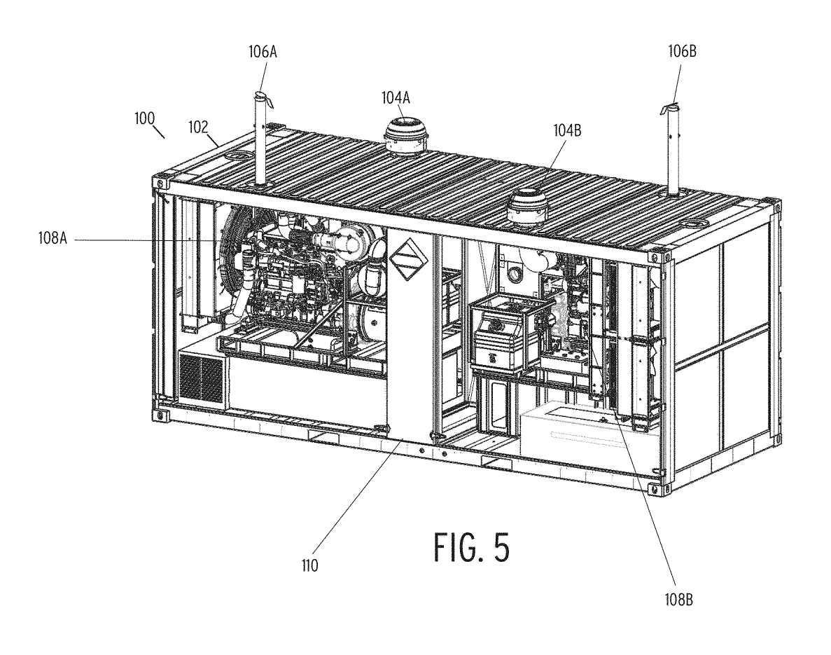

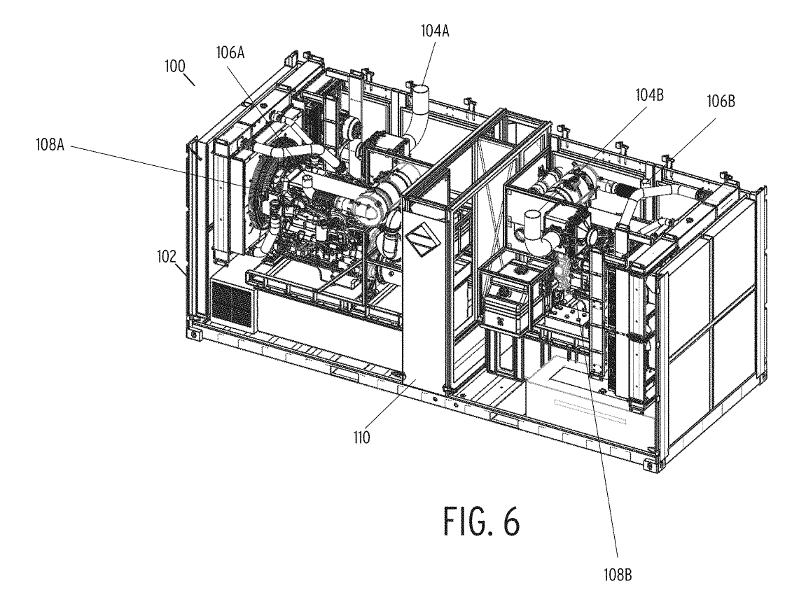

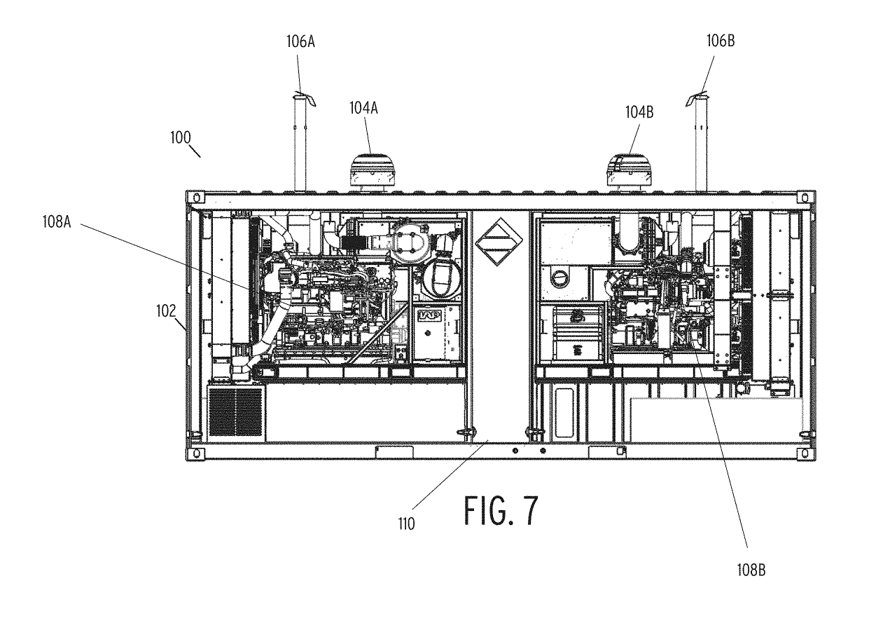

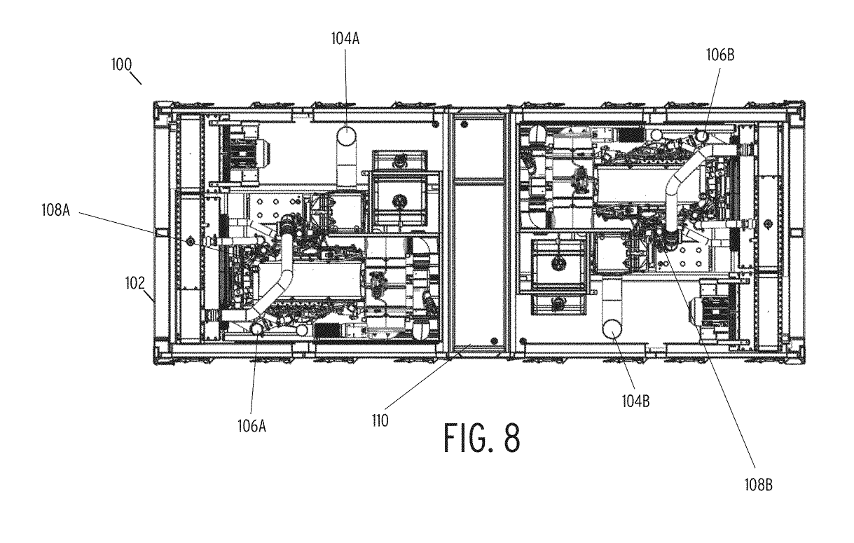

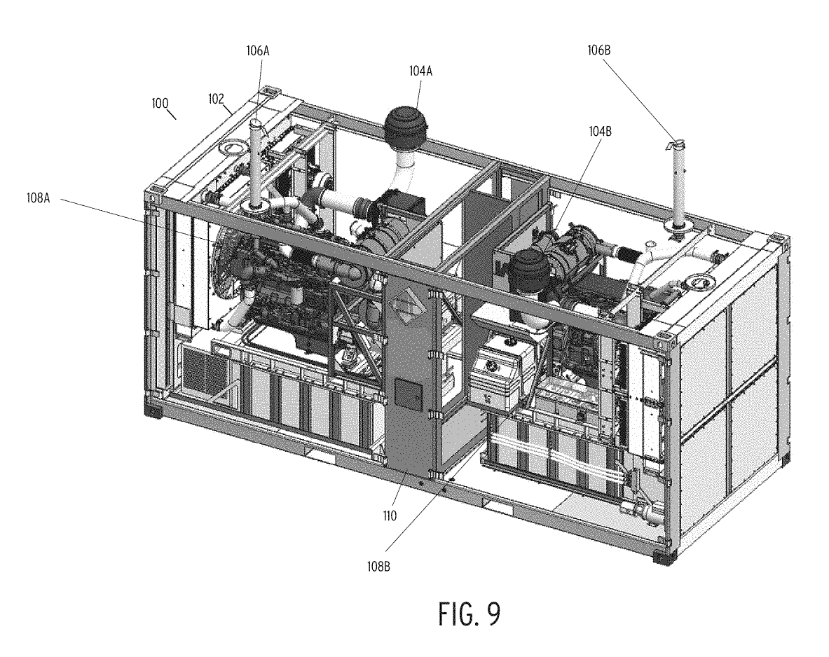

In an embodiment, the modular power supply (100) may comprise several sources of electrical power arranged within a housing (102), as shown in FIGS. 5-9, which illustrate the modular power supply (100) with various portions of the housing (102) removed to view the interior of the plant. As depicted, in an embodiment, a frame (110) may divide the interior of the housing (102) into several compartments, such as three compartments, for example. The modular power supply (100) may include two power supply units (108A, 108B) disposed on opposite ends of the housing (102), i.e., in end compartments situated on the respective ends of the housing (102). In an embodiment, one or both of the power supply units (108A, 108B) may include an engine, which may drive a permanent magnet generator, for example. One or both of the power supply units (108A, 108B) may also include batteries and/or other sources of electrical power (which may be coupled to, in an embodiment, renewable sources of energy). Additional equipment to support the operation of the engines may also be disposed in the end compartments and/or in a central compartment between the end compartments. Fans may be disposed on one or more ends or sides of the end compartments for the removal of heat from the end compartments. The fans may be coupled to radiators disposed on the ends of the end compartments for heat exchange with the exterior of the housing (102). Louvers may be disposed on one or more walls of the end compartments to allow cooling air flow while preventing rain, ice and snow from entering the housing (102), to protect the radiator, and to prevent personnel from touching potentially hot and hazardous components, in an embodiment.

The components of the plant may be a mixture of power generators of similar or varied size and output capabilities and of energy storage devices, such as batteries, control equipment and other components as needed to meet particular power output requirements and site conditions. The components of the plant may be designed and configured so that the plant may provide up to a megawatt of power and may store up to three hundred kilowatt-hours of energy or more, in an embodiment.

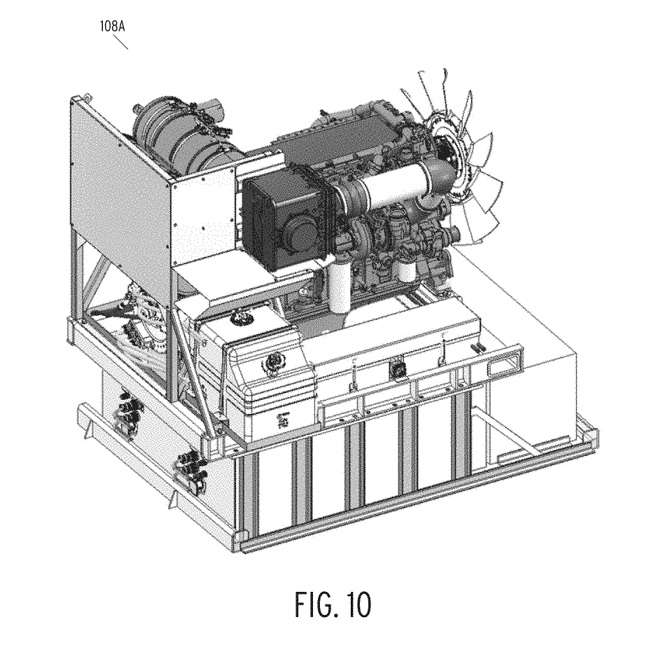

FIG. 10 is an isometric view of a single power supply unit of the modular power supply according to some embodiments of the disclosure.

The modular power supply (100) may include two or more such units, in an embodiment. The power supply unit may include a power generation module (which may include a permanent magnet generator) and an energy storage subsystem. In an embodiment, the energy storage subsystem may include one or more batteries. The power generation module may produce up to 500 kW of power, in an embodiment. Each energy storage subsystem may store up to 150 kWh of energy, in an embodiment. In an embodiment, the power generation module and energy storage subsystem are coupled together and may be removed separately or together for repair or replacement while another power supply unit of the modular power supply (100) may continue to supply power.

In an embodiment, the modular power supply (100) may operate in the state illustrated in FIGS. 1-4, i.e., with all sides and doors of the housing (102) in place. Alternatively, one or more sides or doors of the housing (102) may be opened for, e.g., user access to the components of the modular power supply (100) for service or repair and/or removal of the components of the modular power supply (100) from the housing (102).

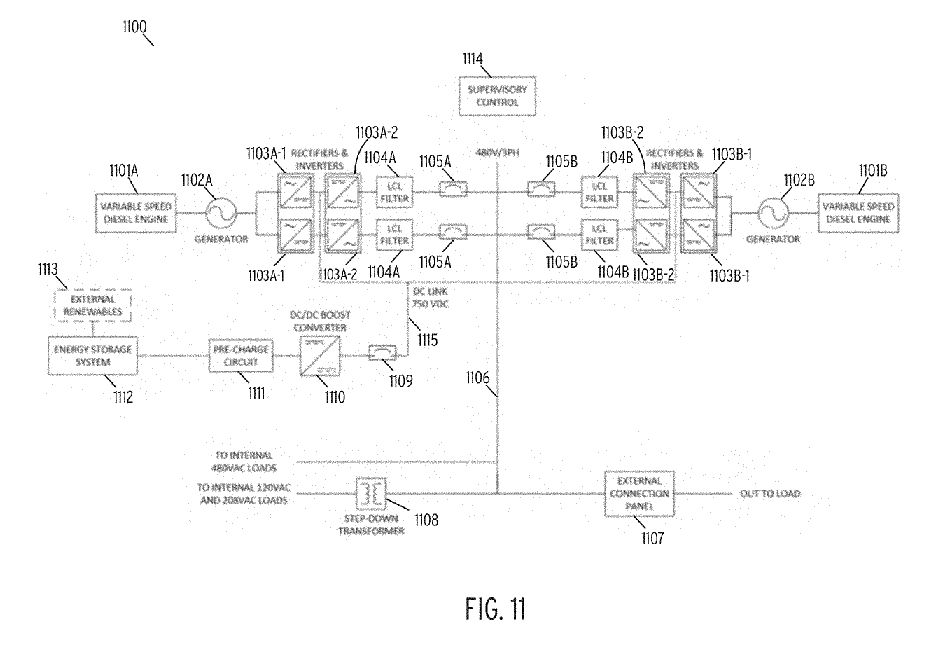

FIG. 11 is a circuit diagram of a modular power supply (1100) according to some embodiments of the disclosure.

As illustrated in FIG. 11, the two engines (1101A, 1101B) of the modular power supply (1100) may be electrically coupled to respective permanent magnet generators (1102A, 1102B), the output of which may be coupled to respective power management electronics (1103A-1, 1103A-2, 1103B-1, 1103B-2) (each of which may comprise, for example, inverters and rectifiers).

In one embodiment, the power management electronics (1103A-1, 1103A-2, 1103B-1, 1103B-2) may both be coupled to a 480V AC bus (1106) through respective LCL filters (1104A, 1104B) and breakers (1105A, 1105B). The bus (1106) may also be electrically coupled to internal loads (e.g., to the energy storage system (1112) for charging batteries of the energy storage system (1112), to control electronics, etc.) via a step-down transformer (1108) and to external loads through an external connection panel (1107).

The modular power supply (1100) additionally includes a DC link (1115). In one embodiment, the link (1115) comprises a 750 V DC power bus. DC link (1115) connects the energy generation subsystem to the main power bus (1106).

The output from the batteries of the energy storage system (1112) may also be electrically coupled (through breakers (1109), in an embodiment) to the power management electronics (1103A-1, 1103A-2, 1103B-1, 1103B-2) for providing power to the bus (1106). In addition, other sources of DC current, such as external renewable energy sources (1113), may be coupled to the energy storage system (1112) for charging batteries of the energy storage system (1112) through a pre-charge circuit (1111), a boost converter (1110), and a breaker (1109).

Optional systems that can be associated with the modular power supply (1100) include renewable energy sources (1113) such as solar arrays or wind power units or hydropower units. In these configurations, energy storage system (1112) may be charged from such renewable sources. In the illustrated configuration, where the generators (1102A, 1102B) of the modular power supply (1100) may be very efficient for their size, variable demand may be met with stored energy from the energy storage system (1112) and/or by switching on one or both highly efficient generators (1102A, 1102B). The systems of the present disclosure may result in cost savings of about 30% (depending on load conditions) over some of the more conventional power supply solutions on the market today.

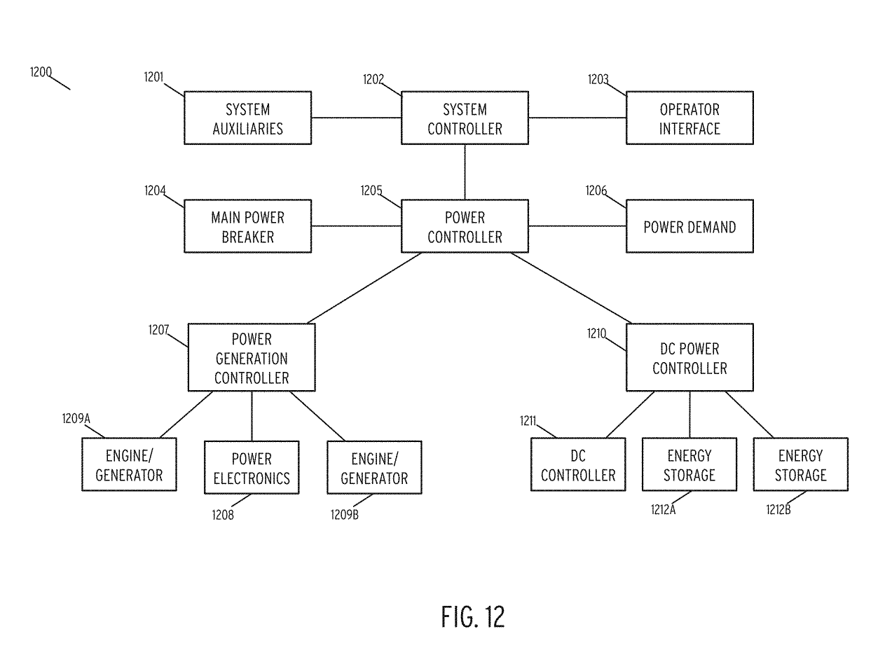

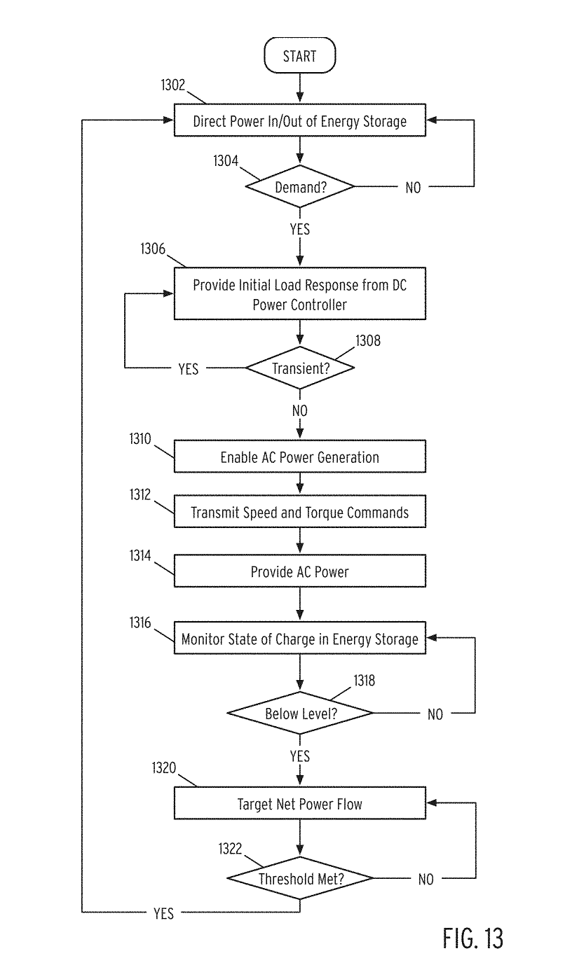

The modular power supply (1100) additionally includes a supervisory control system (1114), described in more detail with respect to FIGS. 12 and 13. In general, the supervisory control system (1114) may be connected to various controllers for the devices described above. The supervisory control system (1114) directs and controls the operation of the modular power supply (1100) by monitoring loads and power levels of the components and dynamically modifying the operation of the system in response to current loads.

A modular power supply (1100) according to the present disclosure may find use in a variety of configurations. For example, a modular power supply (1100) according to the present disclosure may find use as a stand-alone power source for a site. In another example, a modular power supply (1100) according to the present disclosure may find use as a part of a “microgrid” in which multiple copies of the modular power supply (1100) according to the present disclosure and/or other generators are electrically coupled to each other (e.g., in parallel) to jointly provide power for a site. In another example, a plant according to the present disclosure may find use tied to a main utility grid to provide power to or in conjunction with that grid.

Some key advantages of a power supply plant according to the present disclosure may include, but are not limited to: low fuel consumption and running costs, energy storage from renewables, low emissions directly related to energy required rather than energy produced, adaptable multiple permutations dependent on client requirements, modular design, and the ability to service without total loss of power.

FIG. 12 is a system diagram of a supervisory control system according to some embodiments of the disclosure.

As will be described herein, the supervisory control system (1200) controls the operation of the power generation subsystem and energy storage subsystem discussed above in connection FIG. 11. Some or all of the supervisory control system (1200) may be implemented as software, hardware, or a combination thereof. In one particular embodiment, components of the supervisory control system (1200) comprise software running on a programmable logic controller (“PLC”) or similar system.

In the illustrated embodiment, the supervisory control system (1200) includes a system controller (1202). In one embodiment, the system controller (1202) is responsible for managing the overall operation of the supervisory control system (1200). That is, the system controller (1202) is a centralized control interface for controlling auxiliary devices (1201) as well as power controller (1205) and, by proxy, power generation controller (1207) and DC power controller (1210).

In addition to controlling various devices of the supervisory control system (1200), the system controller (1202) additionally monitors the status of each device in the system. As used herein, a “device” refers to both the controller devices (1205, 1207, 1210, and 1211) and auxiliaries (1201) as well as the power components including engine/generator (1209A, 1209B), energy storage (1212A, 1212B), and main power breaker (1204) which are described in more detail in FIG. 11. In some embodiments, monitoring of the power components may be performed through the controllers (1207, 1210, 1211) while in other embodiments monitoring may be performed by directly accessing the power components themselves.

In some embodiments, each device generates one or more status signals that indicate the operational status of the device. In one embodiment, status signals may be broadcast or unicast on a shared bus connected to the system controller (1202). Alternatively, in some embodiments, the system controller (1202) may be integrated with the various controller devices and may receive status signals via an API or similar mechanism.

In response to status signals, the system controller (1202) coordinates the storage and processing of the status of each device in the supervisory control system (1200) while the supervisory control system (1200) is in operation. For example, the system controller (1202) may generate one or more log files recording the historical and current status of each device in the supervisory control system (1200). Additionally, the system controller (1202) may include status processing software for generating reports, alerts, or other data based on the status signals.

In general, the system controller (1202) acts as a centralized controller for the operation of the supervisory control system (1200). To facilitate this control, the system controller (1202) provides an operator interface (1203). In some embodiments, the operator interface (1203) comprises a graphical user interface (GUI). In alternative embodiments, the operator interface (1203) may comprise a terminal-based interface, an API, or a physical interface (e.g., an interface with manual controls and indicator lights). In general, the operator interface (1203) may comprise any suitable mechanism for allowing an operator to monitor and control the supervisory control system (1200) and the specific form of the interface is not intended to be limited herein.

As discussed above, the system controller (1202) manages the operation of system auxiliaries (1201). In one embodiment, the system auxiliaries (1201) comprise any devices not directly controlling the power generation or storage (described above). For example, the system auxiliaries (1201) may include various subsystems such as cooling subsystems, input power subsystems, supervisory control system (1200) power sources, data communications subsystems, cellular or satellite subsystems, etc.

The system controller (1202) is communicatively coupled to the power controller (1205). In some embodiments, the system controller (1202) may be coupled to the power controller (1205) via a broadband communications bus (e.g., Ethernet, Infiniband, etc.). In other embodiments, the system controller (1202) may be coupled to the power controller (1205) via a serial data bus or similar bus.

The power controller (1205) primarily controls the operation of the power components of the supervisory control system (1200). At a high level, the power controller (1205) is responsible for managing and optimizing the efficiency of the supervisory control system (1200). Specifically, the power controller (1205) determines the optimal power delivery of the supervisory control system (1200) based on a current load placed on the supervisory control system (1200). To that end, the power controller (1205) receives, as an input, a continuous power load placed on the supervisory control system (1200). In addition to monitoring the load and controlling the power and storage subsystems, a power controller (1205) additionally handles the start-up and shutdown of the supervisory control system (1200) as well as the various components therein. The power controller (1205) additionally allows for operator (or automatic) control of the various breakers (including the main output power breaker (1204)) discussed in connection with FIG. 11. As will be discussed herein, lower level control of the system (e.g., power generation and power storage) may be undertaken by subsystems and individual device controllers.

The supervisory control system (1200) includes a DC power control system including a DC power controller (1210), a DC controller (1211), and energy storage subsystems (1212A, 1212B). Energy storage subsystems (1212A, 1212B) were discussed in connection with FIG. 11 and the details of the storage are not repeated herein for the sake of clarity, but are incorporated herein by reference in their entirety.

In one embodiment, the DC controller (1211) operates in a voltage control mode. As used herein, a voltage control mode refers to a mode of operation wherein the DC controller (1211) automatically directs power out of or into energy storage subsystem (1212A, 1212B) as the load on the supervisory control system (1200) changes. In this manner, the DC controller (1211) maintains the DC bus voltage at 750V (discussed above), without the need for explicit command and control by the power controller (1205).

As discussed above, a power controller (1205) monitors power demand (1206) on the supervisory control system (1200). In one embodiment, once the power controller (1205) detects a power demand (1206) from outside the supervisory control system (1200), the power controller (1205) instructs the DC power controller (1210) to provide the initial load response. In one embodiment, the supervisory control system (1200) is configured to meet up to fifty percent instantaneous load changes.

The supervisory control system (1200) includes a power generation subsystem including a power generation controller (1207), power electronics (1208), and engine/generator subsystems (1209A, 1209B). In the illustrated embodiment, the power electronics (1208) may comprise rectifiers, inverters, LCL filters, and other components such as those depicted in FIG. 11, the details of which are incorporated herein by reference. Similarly, engine/generator subsystems (1209A, 1209B) may include two sets of engines and generators such as those depicted in FIG. 11, the details of which are likewise incorporated herein by reference. While illustrated as a single subsystem, the system may include multiple power generation subsystems, e.g., dual subsystems as depicted in FIG. 11.

In one embodiment, the power generation controller (1207) is brought up or online by the power controller (1205) if the power controller (1205) detects that the load placed on the supervisory control system (1200) is more than transient. In the illustrated embodiment, power generation controller (1207) transmits a speed command to the engine/generator subsystems (1209A, 1209B) in response to being brought up by power controller (1205). Additionally, power generation controller (1207) transmits a torque command to the power electronics (1208) (e.g., to one or more rectifiers) in response to being brought up by power controller (1205). In one embodiment, the speed and torque commands are based on a maximum efficiency operating line predetermined by an operator or preset by the system controller (1202) or power controller (1205). In this manner, the power provided by the supervisory control system (1200) is always generated at an optimal point.

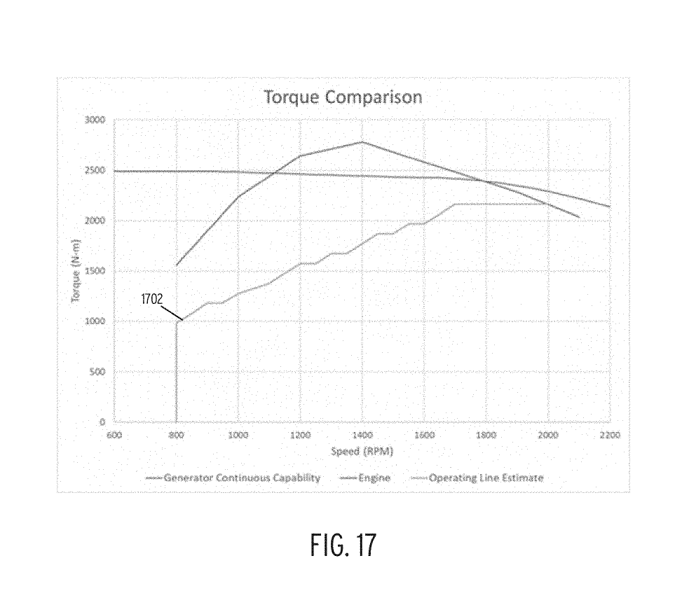

In determining a maximum efficiency operating line, reference is made to FIG. 17. Line (1702) represents the optimum operating line for the power generation system. That is, line (1702) represents the operating line where the engine and generator are operating at as near their maximum efficiency as possible. This efficiency is vital to the lower fuel consumption figures achieved by the modular power system of the disclosed embodiments. In contrast, conventional power generation plants do not do this. The optimum operating line may be changed based on performance information gleaned from component suppliers.

The operation of the power generation subsystem and the DC power control system work in tandem to optimize generation efficiency of the supervisory control system (1200). Specifically, the utilization of stored energy (via DC power control system) and a delayed generation response (via power generation subsystem) optimizes generation efficiency and allows transients to be met from the energy storage alone and prevents unnecessary engine start, stops, speed and load changes on the engine-generator, reducing power generation system usage (and therefore reducing maintenance costs and increasing maintenance intervals).

FIG. 13 is a flow diagram illustrating a method for optimizing generation efficiency of a modular power supply according to some embodiments of the disclosure.

In step 1302, the method directs power into and out of an energy storage system. As described above, a DC controller operates in a voltage control mode and will automatically direct power out of or into the energy storage as loads change in order to maintain the DC bus voltage at 750V, without the need for commands from the power controller.

In step 1304, the method detects that a power demand exists outside of a system implementing the method. This detection may be performed by a power controller monitoring the demand placed on the system by external devices connected to the system. Alternatively, if no demand is placed on the system, the method continues to control the flow of power from the stored energy subsystem in step 1302. Alternatively, or in conjunction with the foregoing, if the charge of the battery in the stored energy subsystem falls to a minimum level, one or more power generation units will begin recharging the battery or batteries, as described in more detail below.

In step 1306, the DC power controller provides the initial load response to the demand. In one embodiment, the method may supply up to fifty percent of instantaneous load changes placed on the system via the energy storage subsystem.

In step 1308, the method determines if the demand placed on the system is a transient demand. As known in the art, a transient demand (or load) is a temporary spike in demand (or load) placed on a power system. The method may determine whether the demand is transient or not by comparing the demand over time to determine whether the demand continues for a pre-determined amount of time. If the demand is indeed transient, the demand may be supplied by the stored energy subsystem (in step 1306) as part of the initial load response.

Alternatively, in step 1310, after the method determines that the demand is not transient (i.e., is a sustained demand), the method enables AC power generation in step 1310. As part of this step, the method may enable a power generation controller to start an engine and/or power electronics, as described in more detail below.

In step 1312, the method transmits speed and torque commands to the power generation equipment. In one embodiment, the method transmits a speed command to control the speed of an engine control unit of a variable-speed engine such as engine 1101A or 1101B in FIG. 11. The method may additionally issue a torque command to a rectifier such as rectifiers 1103A-1 or 1103B-1 illustrated in FIG. 11. In one embodiment, the speed and torque parameters are determined based on a maximum efficiency operating line.

Notably, the above steps allow for the optimization of generation efficiency by allowing transient demands to be met solely from energy storage alone. The method also prevents unnecessary engine start, stops, speed, and load changes on the engine and generator. Further, the method reduces power generation subsystem usage, thereby reducing maintenance costs and increasing maintenance intervals.

In step 1314, the method provides AC power via the power electronics. In one embodiment, AC output power is provided via the power electronics automatically once enabled in steps 1310 and 1312.

In step 1316, the method monitors the state of charge in the energy storage.

As described, a power controller is configured to receive a state of charge signal from the energy storage (e.g., battery storage) and compares the current state of charge to one or more pre-set levels.

In step 1318, the method determines if the state of charge is below a preset level. If not, the method continues to monitor the state of charge of the energy storage.

Once the state of charge falls below a preset level, the method targets net power flow into the energy storage in step 1320. In one embodiment, the batteries of the stored energy subsystem have an optimum band of charge. When the minimum level of charge is reached the supervisory control system will divert some of the available generated power into charging the batteries until the maximum charge level is reached.

In step 1322, the method determines if an upper threshold for the state of charge is met. If not, the method continues to target net power flow into the energy storage in step 1320. In some embodiments, an upper threshold for the state of charge may be set by the operator of the system or may be determined based on historical power usage of the system implementing the method.

Alternatively, if the upper threshold is met, the method directs power into and out of energy storage in step 1302. In this embodiment, the method may instruct the power generation components (e.g., engine, generator, and rectifier) to stop operation, thus transferring the load to the energy storage. In some embodiments, the method may delay the immediate transfer of the load to the energy storage for a predetermined amount of time.

Although described in the context of a single control system for single modular power supply, one may equally apply the embodiments in FIGS. 12 and 13 to multiple power supplies. As illustrated in FIG. 12, the modular power supply includes dual power generation subsystems (engines, generators, etc.) and dual energy storage systems. In the embodiment illustrated in FIG. 12, the method would be modified to add the capability to synchronize the electrical AC output of the power electronics from two engine/generators to allow for the case where both engine/generator sets are required to meet the power demand. The energy storage subsystem would additionally have added capacity in terms of additional energy storage but is otherwise unchanged in terms of control. This results because the energy storage side of the module power system is capable of handling a 50% step load change.

In another embodiment, multiple power supplies may be arranged in sequence or parallel (as discussed above). In some embodiments, a single system controller may be used to monitor each power supply unit. In some embodiments, the power controller may be distributed to each power supply unit while in other embodiments a single power controller may be utilized. In some embodiments, each modular power supply may include its own power generation controller and DC power controller while in other embodiments these controllers may also be centralized.

In a multiple-supply environment, the processing of FIG. 13 may be modified to support multiple DC and AC power sources. First, the method may be modified to increase the length of a transient load. This may be extended because multiple DC power sources exist and are capable of handling a longer transient load. Alternatively, the method may selectively switch between AC and DC power sources on a per-power supply basis. Further, the method may selectively charge energy storage devices using AC power generation components from other power supply units.

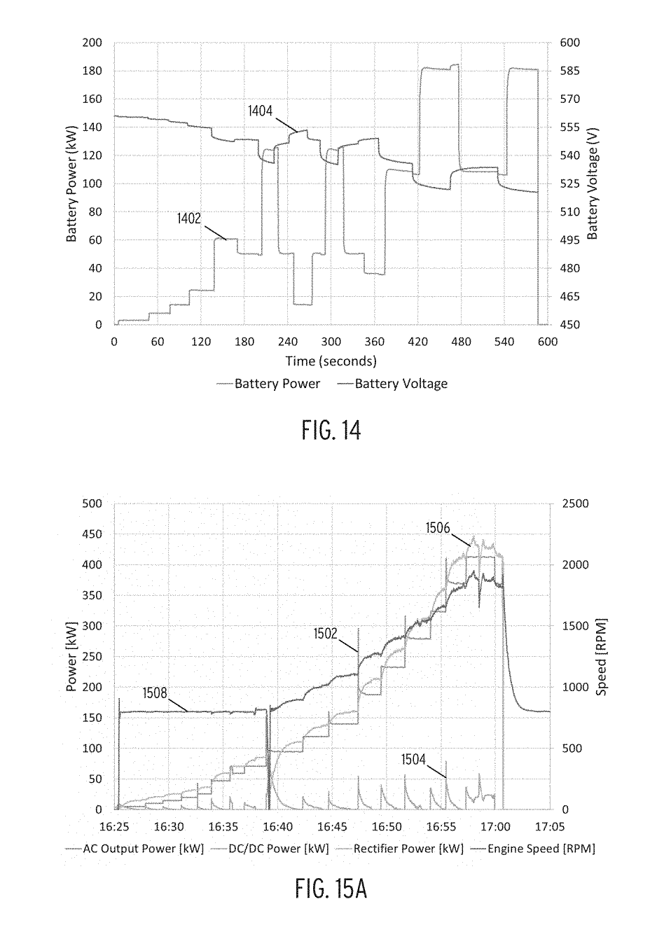

FIG. 14 is a graph of the output voltage and power of an energy storage device according to some embodiments of the disclosure. The graph in FIG. 14 illustrates the response of modular power supply responding to small (5 kW) and larger 50 (kW) instantaneous changes. The modular power supply tested in FIG. 14 utilizes one energy storage subsystem with two battery packs rated 56 kWh, 200 kW continuous discharge rating (665 kW peak discharge rating). In the illustrated graph, only the energy storage components of the modular power supply were enabled during testing.

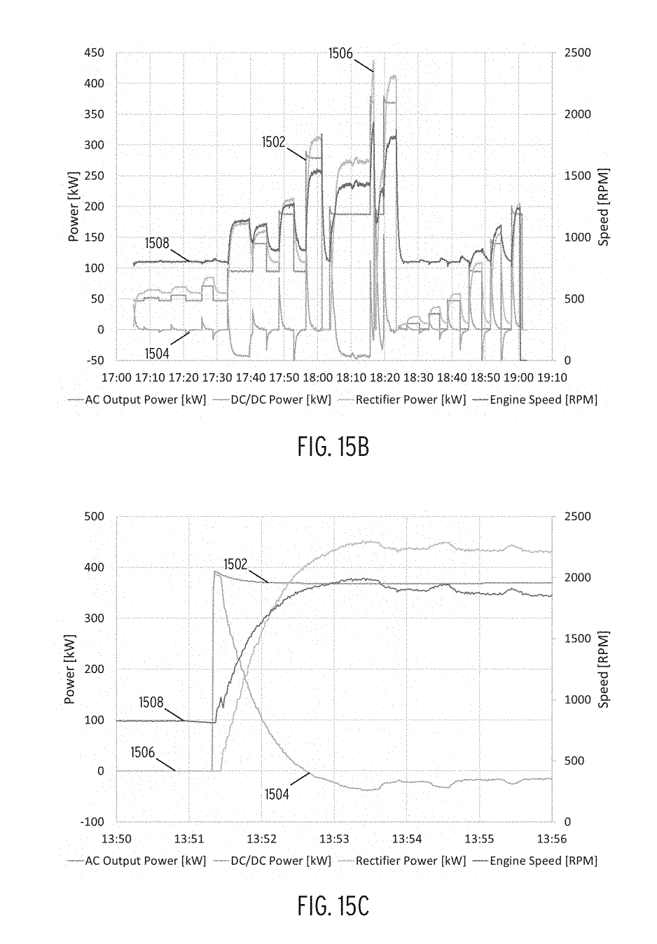

FIGS. 15A-15D are graphs of the output power of various components of a modular power supply when subjected to various power demands. In each figure illustrated a connected load or, power demand, (1502), an energy storage output (1504), a generator output (1506) as well as the speed of the engine (1508). While FIG. 14 illustrated the operation of the energy storage alone, FIGS. 15A-15D illustrate the operation of the system operating with both power generation and energy storage connected.

FIG. 15A illustrates that as the load (1502) increases, the initial load is taken by the energy storage (1504) while the power electronics increases the output (1506) from the generator. As this generated power (1506) increases, the power supplied from the energy storage (1504) is reduced to zero. When the power demand (1502) reaches just over 150 kW, the system increases the engine speed (1508) to meet the power demand (as determined from the operating line, discussed supra). Note that a sudden drop in engine speed (1508) at 16:40 represents an unplanned engine fault which caused the engine to “cough.” Notably, despite the cough, the energy storage system immediately reacted to service the load. It should be noted that the ‘spikes’ in the power demand (1502) are a function of the load bank and not relevant.

FIG. 15B illustrates the dynamic performance of the modular power system when it is subjected varying up, and down, load changes. It also shows when the energy storage power (1504) goes negative while the batteries being charged by the power generation system (e.g., around approximately 17:35) as discussed supra.

FIG. 15C illustrates the modular power system responding to a single step (instantaneous) load change of 385 kW. As can be seen, energy storage (1504) initial handles the entirety of the power demand (1502). Simultaneously, engine speed (1508) and corresponding generator output (1506) increases to handle the decreasing power of energy storage (1504). Note that between 13:52 and 13:53, the generator power exceeds the AC output (1502). At this point, energy storage (1504) is depleted and must be recharged.

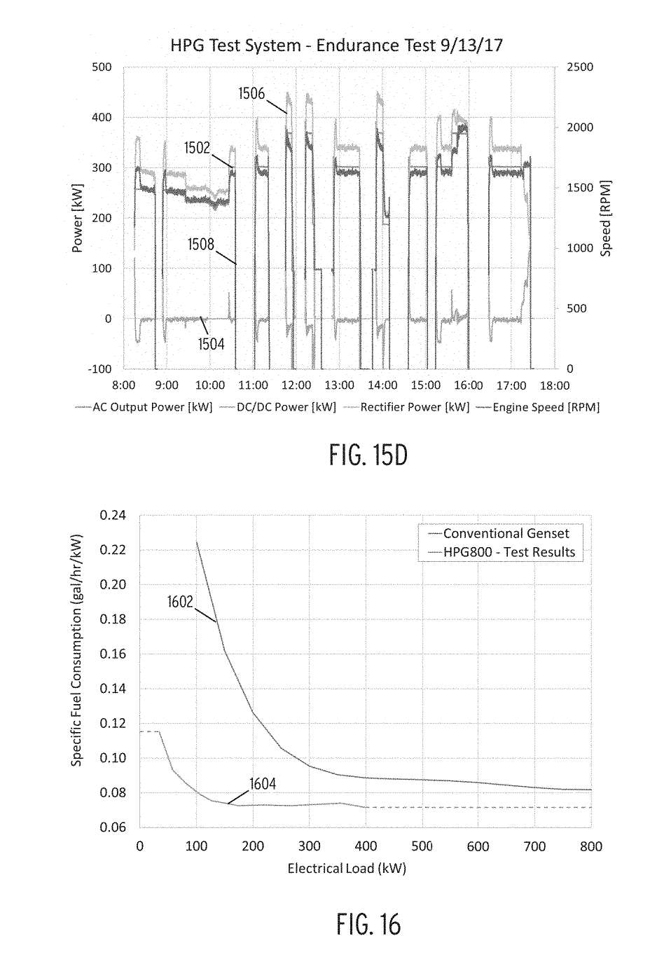

FIG. 15D illustrates the performance of the modular power supply system during an endurance test running a ‘community load profile’ or a representative load change situation. The load profile which was determined from typical loads seen in an ‘island’ or camp situation during daylight hours. These tests were used to generate the fuel efficiency curves shown in FIG. 16. Note that the output in FIG. 15D illustrates anomalous drops in output caused by testing conditions. For example, at approximately 10:30, all data monitored power or speed drops below zero. Other examples of similar anomalies occur at approximately 11:15, 11:55, 12:30, 13:30, 14:15, 15:00 and 16:00. Such events represent shutdown anomalies caused by external testing site factors and do not represent the actual output of the system in operation. Specifically, during testing the system was configured with a temperature-based trigger that shutdown the system if the operating temperature reached a predetermined threshold, so as to avoid triggering test site fire prevention devices.

FIG. 16 illustrates the improved, reduced fuel consumption achieved the disclosed embodiments. Line (1602) is data from a modem (current specification) conventional diesel generator set of similar capacity. Line (1604) is data from the modular power supply described herein. The dotted line (1606) is a projection of the likely performance of the modular power supply system described herein. The reason that the lower power level in dotted line (1606) is that the modular power supply will at some point only run on stored energy, starting the generator to charge the batteries.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and systems. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus (e.g., PLC), such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure any computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

What is claimed is:

1. A modular power supply system comprising:
a housing comprising an equipment enclosure conforming to the requirements of a standard container;
a plurality of power generation modules housed at respective ends of the housing, a respective power generation module including a variable speed diesel engine coupled to a generator, a pair of rectifiers coupled to the generator, a pair of inverters coupled to the rectifiers, an LCL filter coupled to each inverter, a breaker coupled to each LCL filter, the breakers connected to a central AC power bus; and
a plurality of energy storage subsystems housed at respective ends of the housing, a respective energy storage subsystem comprising one or more batteries connected to a pre-charge circuit, a DC/DC boost converter connected to the pre-charge circuit, and a DC power bus connected to the input of the inverters.

2. The system of claim 1, wherein the housing further comprises one or air intake and exhaust ports.

3. The system of claim 1, further comprising a supervisory control system including programmable logic for:
detecting the presence of a power demand on the modular power supply;
powering the power demand via the energy storage subsystems in response to detecting the presence of the power demand;
enabling AC power generation from the power generation modules after determining that the power demand is not a transient demand;
monitoring a state of charge of the energy storage subsystems; and
targeting a net power flow upon determining that the state of charge of the energy storage subsystems falls below a predetermined level.

4. A supervisory control system comprising:
a communications bus;
a power controller coupled to the communications bus and including programmable logic configured to monitor a power demand attached to a power supply system managed by the supervisory control system;
a DC power controller coupled to the power controller via the communications bus and including programmable logic configured to manage the operation of an energy storage subsystem included in the supervisory control system, wherein the DC power controller includes programmable logic configured to operate the energy storage system in a voltage control mode; and
a power generation controller coupled to the power controller via the communications bus and including programmable logic configured to manage power electronics and an power generation subsystem included in the supervisory control system, wherein the power generation controller is brought online by the power controller if the power controller detects that the power demand placed on the power supply system is more than a transient demand.

5. The supervisory control system of claim 4, further comprising a system controller coupled to the communications bus and including programmable logic configured to monitor the status of each device and controller in the supervisory control system.

6. The supervisory control system of claim 4, wherein the DC power controller includes programmable logic configured to automatically direct power out of or into the energy storage subsystem as the power demand on the power supply system changes, wherein changes in the power demand are detected by the power controller.

7. The supervisory control system of claim 6, wherein the DC power controller includes programmable logic configured to maintain a DC bus voltage at 750 V.

8. The supervisory control system of claim 4, wherein the power controller includes programmable logic configured to instruct the DC power controller to provide an initial load response to the power demand.

9. The supervisory control system of claim 4, wherein, in response to being brought online by the power controller, the power generation controller includes programmable logic configured to transmit a speed command to an engine in the power generation subsystem and a torque command to power electronics in the power generation subsystem.

10. The supervisory control system of claim 9, wherein the speed and torque commands are based on a maximum efficiency operating line.

11. The supervisory control system of claim 4, wherein the power controller includes programmable logic configured to:
monitor a state of charge of the energy storage system; and
target a net power flow upon determining that the state of charge of the energy storage system falls below a predetermined level.

12. The supervisory control system of claim 11, wherein the power controller includes programmable logic configured to determine if an upper threshold for the state of charge is met and, if so, power the power demand via the energy storage subsystem

13. A method comprising:
detecting the presence of a power demand on a modular power supply, the modular power supply including a power generation subsystem and energy storage subsystem;
powering the power demand via the energy storage subsystem in response to detecting the presence of the power demand;
enabling AC power generation after determining that the power demand is not a transient demand;
monitoring a state of charge of the energy storage system; and
targeting a net power flow upon determining that the state of charge of the energy storage system falls below a predetermined level.

14. The method of claim 13, further comprising automatically directing power out of or into the energy storage subsystem as the power demand changes in order to maintain a constant DC bus voltage.

15. The method of claim 13, further comprising supplying up to fifty percent of instantaneous load changes placed via the energy storage subsystem.

16. The method of claim 13, where determining that the power demand is not a transient demand comprises comparing the power demand over time to determine whether the power demand continues for a pre-determined amount of time.

17. The method of claim 13, wherein enabling AC power generation further comprises transmitting speed and torque commands to the power generation subsystem.

18. The method of claim 17, wherein the speed and torque parameters are determined based on a maximum efficiency operating line.

19. The method of claim 13, further comprising diverting a portion of the available power generated by the power generation subsystem into charging one or more batteries of the energy storage subsystem until the maximum charge level is reached upon determining that a minimum level of charge is reached.

20. The method of claim 13, further comprising determining if an upper threshold for the state of charge is met and, if so, powering the power demand via the energy storage subsystem.

21. The method of claim 20, wherein after powering the power demand via the energy storage subsystem the method further comprises issuing an instruction to stop components of the power generation subsystem.
